(19) United States
(12) Patent Application Publication
(10) Pub. No.: US 2010/0025418 A1
(43) Pub. Date: Feb. 4, 2010

(54) VENDING MACHINE WITH VIDEO DISPLAY

(76) Inventor: Munroe Chirnomas, Morris Township, NJ (US)

Correspondence Address: LAWRENCE C. EDELMAN, ESQ;IP COUNSEL, AUTOMATIC IMPULSE MACHINE DESIGN, 3 BUFFALO RUN, EAST BRUNSWICK, NJ, 08816, US

(21) Appl. No.: 12/515,738

(22) PCT Filed: Aug. 15, 2007
(86) PCT No.: PCT/US2007/076053

§ 371 Date: May 20, 2009

Related U.S. Application Data
(60) Provisional application No. 60/822,477, filed on Aug. 15, 2006.
(60) Provisional application No. 60/845,694, filed on Sep. 19, 2006.

(51) Int. Cl. A47F 1/04; H04N 5/66

(52) U.S. Cl. 221/24; 221/155; 348/739

(57) ABSTRACT

Methods and apparatus are disclosed relating to the provision of a video display device within an article vending machine, such video display being used to provide one or more of an “entertainment”, “advertising” and/or an “interactive product selection” enhancement to the vending machine.

### CROSS-REFERENCE TO RELATED APPLICATIONS

This application claims priority under 35 USC 120 of U.S. Provisional Patent Application No. 60/822,477 filed Aug. 15, 2006 and of U.S. Provisional Patent Application No. 60/845,694 filed Sep. 18, 2006. The disclosures of both of these patent applications are incorporated herein by reference in their entirety.

### BACKGROUND OF THE INVENTION

1. Field of the Invention

The present invention concerns methods and techniques relating to the provision of a video display device within an article vending machine, such video display being used to provide one or more of an “entertainment”, “advertising” and/or an “interactive product selection” enhancement to the dispensing display face of the vending machine.

2. Background Information and Description of the Related Art

My earlier published prior U.S. Pat. No. 5,240,139, as well as any one of my more recently issued patents, such as U.S. Pat. No. 6,868,983 (entitled Method And Apparatus For Positioning An Article Handling Device), disclose automatic vending machines which use a robotically controlled dispensing mechanism in order to retrieve and dispense to a user of the vending machine, packaged articles from inside a storage area of the vending machine.

With an article dispensing apparatus such as described in my prior patent publications, it is known to include what is referred to as a clear area or “window” on a front facing exterior graphic display side of the vending machine. Such front display face typically comprises a LEXAN® or other tough and durable plastic material that is affixed to a mounting frame part of a front door portion of the vending machine. In the event that the mounting frame is curved, the curved plastic front may be referred to as a “bubble front” display face.

The front display face typically has graphic images included thereon which may be representative of the articles which are stored therein and are selectable by a user of the vending machine. Such graphic images may be permanently affixed thereto, such as by use of a printing process, or may be selectively attached to a clear portion or portions of the display face by the use of individual display cards that are affixed to an interior facing side of the display face. A clear area or “window” in the front graphic display which is not blocked by a graphic image, such as the large window shown in my forenoted U.S. Pat. No. 5,240,139, allows potential users of the vending machine to have a “view” into the machine, thereby presenting the opportunity for the window to provide an “entertainment” value to the vending machine; the entertainment effect helping attract potential users to the machine, and thereby stimulate increased sales from the machine for the owner/operator of the vending machine.

It would be desirable to include a video display in conjunction with such a vending machine, for entertainment, advertising, or even interactive use.

### SUMMARY OF THE INVENTION

In accordance with one aspect of a preferred embodiment of the present invention, a dispensing machine, configured as a vending machine comprises a housing including therein an article storage area and an article dispensing apparatus for moving selected articles from the storage area and dispensing them to a user of the vending machine. An exterior portion of the vending machine housing includes a clear portion so as to form a “viewing window” into the vending machine. A video display device, which may also include an audio source, is positioned inside the housing and behind at least a portion of the window, so that a substantial portion of the video display is visible through the window. In a preferred embodiment the video display device is mounted on or near an interior wall in the housing of the vending machine which is opposite to the window, with the front of the video display device facing the window, so that when a user of the vending machine looks toward or into the window, a 3-dimensional “theater box” effect is created in which a substantial portion of the video display device is visible to the user.

By the above arrangement, the use and visibility of the video display advantageously provides a visual (and, if desired, also an audible):
“entertainment” enhancement to the display face of the vending machine,
an “advertising” enhancement to the display face of the vending machine, and
an “interactive product selection” enhancement to the display face of the vending machine, as will be described in greater detail below.

To further the above-noted enhancements, a moving entertainment apparatus is positionable so as to move in a space between the window and the video display device, during at least some of the time before, during or after an article dispensing cycle of the article dispensing apparatus of the vending machine. In one embodiment, the moving entertainment apparatus can include at least a portion of the article dispensing apparatus of the vending machine. Therefore, the moving entertainment apparatus or the article dispensing apparatus can be used to further enhance, for example the entertainment value of the video display device, by moving in front of the video display in coordination with the actual images and/or sounds being presented on the video display. In another embodiment, the article dispensing apparatus can move in front of the video display in a manner not in coordination with the actual images and/or sounds being presented on the video display, but coordinated with some other event, such as the dispensing operations of the machine, etc.

Additionally, the moving entertainment apparatus or the article dispensing apparatus can itself include positioned thereon entertainment devices, such as additional graphics, springs or reflectors, or even active components, such as articulated linkages or moving or rotating mechanisms. Such active components can also include items such as flashing lights, strobe lights, flood lights or LED'S, which can, for example, move in coordination with the actual images and/or sounds being presented on and/or with images being provided by the video display device, thereby further enhancing the entertainment aspects of the video display. Such entertainment apparatus and devices and/or the article dispensing apparatus, can also include a connection to other portions of the vending machine, such as the keypad or other switches or buttons associated with the vending machine, or a joystick or other interface, so as to allow the user an additional way to interact, cause controlled movement of the entertainment apparatus and devices and/or the article dispensing apparatus, or otherwise be entertained by or while viewing the video display device or the entertainment apparatus and devices and/or the article dispensing apparatus. Thus, such movements of the entertainment apparatus and devices and/or the article dispensing apparatus may be coordinated with or triggered by a sequence of images presented to the user by the video display, or other factors, such as the sequence of the dispensing operations of the vending machine, or active inputs by the user of the vending machine, such as by the use of the keypad or joystick.

Even furthermore, the housing of the vending machine may include a “window” on other of its exterior walls, so as to allow additional “views” into the vending machine where the video display can be observed.

Finally, it is noted that one or more mirrors or other image projection devices can be selectively positioned inside of the housing so as to reflect or project the video display toward the window in the panel, so as to substantially increase the usable viewing angle into the window to a person standing outside the machine. In an alternative embodiment, such windows could allow the video display device to not be positioned exactly in line with the window in the panel, and still provide viewing of the display via the window.

### BRIEF DESCRIPTION OF THE DRAWINGS

The accompanying drawings, which are incorporated herein and constitute part of this specification, illustrate embodiments and details of the invention, and, together with the general description given above and the detailed description given below, serve to explain the features of the invention.

FIG. 1 illustrates a side section cut-away view of a vending machine constructed and operating in accordance with the principles of the present invention,

FIG. 2 illustrates a top view of the vending machine of FIG. 1, and

FIG. 3 illustrates a front cut-away view of the vending machine of FIG. 1.

### DETAILED DESCRIPTION OF THE INVENTION

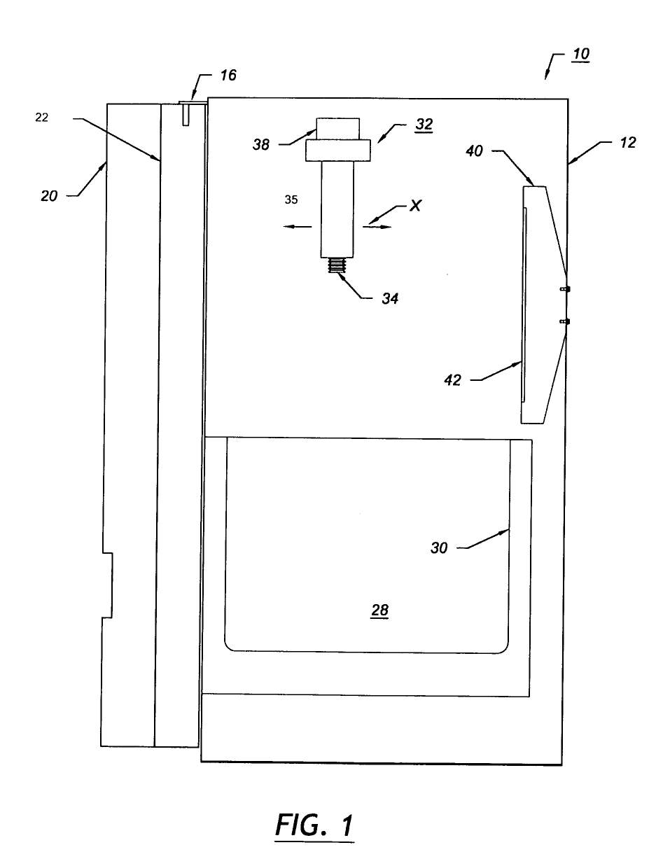

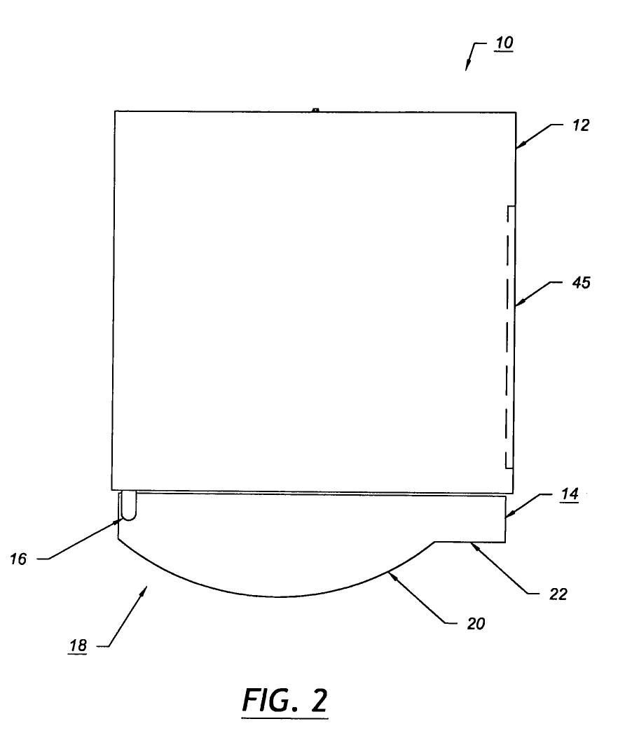

As shown in FIGS. 1 and 2, a vending machine 10 typically includes a housing 12, typically comprised of sheet metal which forms three side walls of housing 12, as well as a top and a bottom portion therefore. A front door 14 is typically constructed of similar material, which is mounted to the open fourth side of the housing 12 via hinges 16. It is noted that other shapes for housing 12 are possible for use with the present invention, such as octagonal, circular, or irregular polyhedron, etc.

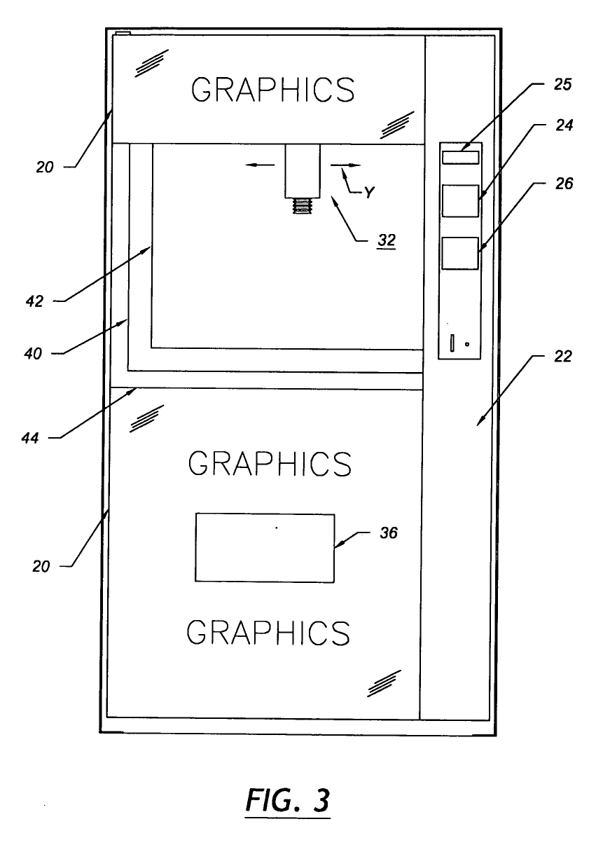

As shown more clearly in the top view of the vending machine in FIG. 2, the door 14 includes a display face 18 having, in the illustrated embodiment, a curved graphics display panel 20, positioned next to a flat panel portion 22. FIG. 3 generally illustrates other conventional portions of vending machine 10, such as the user article selection mechanism 24 (typically comprising article graphics and selection buttons or a keypad), an LED display 25, and a user payment system 26 (typically comprising a coin mechanism and bill validator), which portions are typically mounted wholly or partially on portion 22 of door 14, are generally not necessary for understanding the invention, and therefore no further description will be provided herein unless needed.

Returning again to FIG. 1, the interior of housing 12 includes a storage area 28, which in the illustrated embodiment comprises a thermally insulated box 30, which may contain a plurality of a vertically aligned article storage bins for storing vertical stacks of the articles to be dispensed by vending machine 10, such as shown and described in my above-referenced prior patent publications. Although vertical stacks of the articles are shown in the prior publications, such arrangement is not necessary for the invention described herein, and horizontal or other angular orientation, and even random orientation of the stored articles, is possible.

The upper portion of the interior of housing 12 includes an electronically controlled (i.e., robotic) article retrieving and dispensing device (ARD) 32. ARD 32 can be constructed as is known and shown in my prior U.S. Pat. No. 5,240,139, or as taught by one of my more recently issued patents, such as U.S. Pat. No. 6,868,983, incorporated herein by reference. In a further embodiment of the invention, ARD 32 can even comprise a more conventional “spiral wire” type of article dispenser, alone or in combination with one or more conveyor arrangements. For example, in a spiral wire embodiment, the storage area 28 would comprise a plurality of substantially horizontally oriented shelves in place of box 30, and ARD would comprise an arrangement on the shelves of a plurality of the spiral wire article dispensers.

Briefly, as shown in FIG. 1, ARD 32 includes a carriage 38 which is mounted for sliding lateral movement along a front-back beam (not shown), for allowing carriage 38 to move, for example, in the front/back direction (as shown by axis X in FIG. 1) over the article storage area 28. Furthermore, front-back beam is mounted for sliding lateral movement along a further beam (also not shown), for allowing the front-back beam to move, for example, in the left/right direction (as shown by axis Y in FIG. 3) over the article storage area 28. Motors mounted in the carriage 38 and on the beams, respectively, are controllable for causing sliding lateral movements of ARD 32 to any X-Y position over the storage area 28. A vacuum generator, comprising in the preferred embodiment a blower motor (not shown) provides suction to an article retrieving pickup head 34 via a suction hose coupled between the blower and the pickup head 34. Although not required in all embodiments, in the illustrated embodiment, a guide tube 35 descends from carriage 38 so as to provide guidance which can assist in some applications with stabilizing the end of the suction hose having the pickup head 34 attached thereto.

With the above arrangement, carriage 38 can controllably position article retrieving pickup head 34 to a predetermined X-Y location, such as over a specific article in the article storage area 28. The end of the suction hose which is connected to pickup head 34 is controllably driven in the up/down (Z) direction by, for example, a motor which drives a set of pinch rollers (not specifically shown) which are mounted within carriage 38 and which engage the hose, so as to control the up/down (Z) movement of pickup head 34.

The vending machine includes a control system of conventional design which develops control signals for controlling the motors, as well as activation of the vacuum generator, so that suction is provided to pickup head 34 before or upon its contact with a solid object, which normally is the next article to be dispensed. Altogether, these components, which control the movement of pickup head 34 in the left/right (Y), front/back (X) and up/down (Z) directions, comprise the robotic article retrieving device 32. Of course, the control system also performs all of the other conventional control functions typically required for proper operation of the vending machine. Accordingly, ARD 32 is used to retrieve articles from the storage area 28 and provide them into a customer retrieval area 36 (shown in FIG. 3) for pickup by the user.

Referring again to FIG. 1, and also to the front view of the vending machine shown in FIG. 3, in accordance with one aspect of the invention, a video display device 40, such as an LCD video display, is shown positioned spaced back from the front panel 20. In the illustrated embodiment, video display device 40 is secured on or near an interior wall of housing 12, such as a rear wall which is opposed to the front panel 20, so that the storage area 28 is located between the video display device 40 and the panel 20. By securing the display device 40 relatively deep into the housing of the vending machine, not only is a 3-dimensional “theater” effect created, but the safety and security of the display device 40 is improved as compared to securing it relatively close to the front panel 20. This can reduce the risk of damage to the video display which can occur due to accidents and/or vandalism.

As shown in FIG. 3, in a preferred embodiment, a substantial portion of the active video display area 42 of the display device 40 is aligned with a clear area 44 (“window”) in panel 20.

In an alternative embodiment (not specifically shown), display device 40 could be located in another portion of the interior of housing 12, and one or more mirrors or projecting devices could be used to reflect or project the images from display device 40 toward the window 44. In an even further alternative embodiment, the window 44 can be a clear area 44 formed in a wall of housing 12 which is not the front display panel, but, for example a side wall of housing 12.

Although not specifically shown, one or more speakers can be used in conjunction with display device 40 so as to provide a corresponding audio portion to the video displayed by device 40. The speakers could be integrated with the video display device, or they may have their own enclosures, and may be mounted near the video display device or spaced a distance therefrom. The speakers may even be mounted so as to project their sound to potential users through an opening in the housing.

By the above arrangement, the use and visibility of the video display advantageously provides a visual (and, if desired, also an aural):
“entertainment” enhancement to the display face of the vending machine,
an “advertising” enhancement to the display face of the vending machine, and
an “interactive product selection” enhancement to the display face of the vending machine, as will be described in greater detail below.

For enhancing the entertainment value, a moving entertainment apparatus is positionable so as to move in the space between the window in the panel and the video display device, during at least some of the time before, during or after an article dispensing cycle of the article dispensing apparatus of the vending machine. In one embodiment, the moving entertainment apparatus can include at least a portion of the article dispensing apparatus of the vending machine. This way the moving entertainment apparatus or the article dispensing apparatus can be used to further enhance, for example the entertainment value of the video display device, by moving in front of the video display in coordination with the actual images and/or sounds being presented on the video display, or stated another way, the video and/or audio display may be coordinated to the movements of the ARD

For example, the vending machine controller can be programmed so that different video and/or audio sequences can be displayed depending upon the movement of the ARD. In one embodiment, as the ARD begins its movement, e.g., from a rest/starting position on the right side of the window 44 and along a left/right “X” axis within the vending machine, a first type of video sequence can be displayed, along with a first type of audio, such as a certain pitch whistle or siren. Then, as the ARD changes direction so as to be centered over the storage bin of the selected product, it travels along a different axis, such as the front/back “Y” axis, and a different video and audio sequence can be “triggered”. A further different video and audio sequence can be provided while the article pickup head 34 is moved in the up/down “Z” direction as it retrieves product from the storage area. Even furthermore, upon the ARD releasing the selected article, such as a plastic bottle of water at the drop off point for customer retrieval area 36, a further different video and audio sequence can be provided, such as a video and audio display of a pool of water, with one of the selected bottled water articles “splashing” into the pool. Such splashing sound can serve as a type of “announcement” that the selected article has just been, or is being, delivered to the customer. For items being dispensed which are not beverages, such as an electronic music playing device, an audio and/or video presentation may for example be a simultaneous sound or musical arrangement and/or video images at some point in the dispensing cycle which correlate with or are representative of a product in the vending machine. In this way, it is possible to dispense a distinct variety of items from the machine, where each one of the variety may have a specific set of video or audio presentation which correlates to that specific item being selected, advertised, sold or dispensed.

Such different video and/or audio sequences can be “triggered” by the action of the ARD reaching a specific place, or by the controller of the vending machine as it accomplishes the “dispensing cycle”, from the initial sensing of a potential customer, such as by use of a proximity sensor, or by a customer making an article selection and/or payment, all the way though to drop-off of the selected article to the customer. Such triggering of the display can be accomplished directly by the controller of the vending machine, or by having the controller of the vending machine provide a control signal to a separate “display” controller which is part of the video display unit 40, which display controller controls the display of various video and/or audio sequences that are stored in a memory associated therewith.

In another embodiment, the article dispensing apparatus can move in front of the video display in a manner not in coordination with the actual images and/or sounds being presented by the video display, but in coordination with something else, such as: the sensing of a potential user in proximity to the vending machine, or the result of a user action, e.g., the user placing money into the payment system or the user making an article selection using the keypad, or even merely as the result of the passage of time.

Additionally, the moving entertainment apparatus or the article dispensing apparatus can itself include positioned thereon, such as on guide tube 35, somewhat passive entertainment devices, such as additional graphics, springs or reflectors, or more active components, such as articulated linkages or rotating mechanism, flashing lights, strobe lights, flood lights or LED'S, which can, for example, move in coordination with the actual images and/or sounds being presented on and/or with the video display, thereby further enhancing the entertainment, as well as the advertising aspects of the video display. Such entertainment apparatus can also include connection of other portions of the vending machine, such as the keypad or other switches or buttons associated with the vending machine, or a joystick or other interface, so as to allow the user an additional way to interact, cause controlled movement of the entertainment apparatus, or otherwise be entertained by or while viewing the video display device or the entertainment apparatus. Thus, such movements of the entertainment apparatus, article dispensing apparatus, or additional active or passive components, may be coordinated with or triggered by a sequence of images presented to the user by the video display, or by other factors, such as the sequence of the dispensing operations of the vending machine, or active inputs by the user of the vending machine, such as by the use of the keypad or joystick.

Even furthermore, the housing of the vending machine may include a “window” on other of its exterior walls, such as shown by dashed line (optional) window 45 in FIG. 2, so as to allow additional “views” into the vending machine where the video display can be observed. This window can be in addition to or in place of the first-noted window.

It is noted that one or more mirrors or other image projection or reflection devices (not shown) can be selectively positioned inside of the housing so as to reflect or project the video display toward the window in the panel (or another window), so as to substantially increase the usable viewing angle into the window. In an alternative embodiment, such windows could allow the video display device to not be positioned substantially in line with the window in the panel, and still provide viewing of the display via the window in the panel or another window.

“Advertising” enhancement can be achieved by, for example, attaching one of the articles able to be selected by the user, to the ARD, such as on a front or side facing portion of the guide tube 35, so that an actual example of a selectable article is moved around in front of the display. More specifically, in the example where the vending machine is used for dispensing bottled water, an actual one of the selectable bottles of water can be attached to a side of guide tube 35. A “flood” light mounted on or near carriage 28 can be directed at the bottle, and thereby “showcase” the article to potential users as they pass by the window 44. Furthermore, flashing lights, LED's or other light sources can be positioned on or about guide tube 35, so as to be under the bottle of water attached to the guide tube 35, and even around the top or bottom of the bottle, so that the bottle can refract and/or reflect the light, and thereby create an interesting advertising display of the type of article that is offered for sale. It is noted that such articles could also include bagged food products, such as potato chips, or even larger and/or more expensive non-food articles, such as cell phones, iPods, DVD's, etc

In a further alternative embodiment, some or all of the video and/or audio display can be created simultaneously with dispensing, rather than via previously stored video material. In this case, a video camera can be included in or on the vending machine so as to create “real time” video for presentation on the display 44. In this case, the display can be actual video of the moving robot, and/or video of the user as she selects and then anticipates the dispensing of the selected article.

“Interactive product selection” enhancement is achieved in one aspect of the present invention by having the display device 40 display images of one or more of the articles that are selectable by the user, and such image display can be made interactive by having the image display be responsive to user input to the vending machine, using, for example the keypad, or some other buttons or selection device, or even a joystick type device (not shown) provided on the door and accessible to perspective users.

It is noted that the described embodiments herein are not limited to any particular type of article retrieving device, and other types of article retrieving devices are equally useful. For example, it may be desirable for the robotic positioning mechanism to include a rotary (R, θ) device of the type including an I beam of fixed length (or alternatively telescopic sections), for establishing an “R” (Radial) movement for pickup head 34, and which pivots for establishing a “θ” (Angular) movement. Alternatively, in other environments for the invention the robotic ARD may include an articulated arm or scissor system and could use other types of pickup devices, such as a mechanical claw or scoop, a magnetic attracting device, a portable suction generator, etc. Even furthermore, in an alternate embodiment the article retrieving device may not even be robotic or robotically controlled.

Furthermore, in the environment of the invention, the storage area 28 of the vending machine may keep the articles in a cooled state, such as frozen (for ice cream novelties or frozen foods) or refrigerated (for drinks or fresh food), or the articles can just be kept at the ambient temperature (such as for snack food items or non-food items, such as video cassettes). In the illustrated embodiment storage area 28 happens to include thermally insulated walls which include a refrigeration unit therein so that the stored articles can be kept cool, however, such cooling is not required for the invention described herein. Additionally, as noted above, when this invention is utilized in conjunction with a frozen or refrigerated storage area in the vending machine, such with a freezer as shown in U.S. Pat. No. 5,240,139, various kinds of thermal separating barriers can be used between the ARD 32 and the article storage compartments, such as the sliding segmented thermal lid, or a single large lid hinged to the back of storage area 28, shown in U.S. Pat. No. 5,240,139. Such lids may or may not intermittently block the users view of the video display device 40 when the lid is open during the dispensing part of the dispensing cycle. Alternatively, a sheet having an arrangement of flexible fingers or flaps formed therein, such as shown in my PCT patent publication WO 03/073026 entitled Thermal Barrier For A Refrigerated Vending Machine, could be use over the top of storage area 28, the use of which would not block the users view of the display device 40 during the dispensing operation.

While the present invention has been disclosed with reference to certain embodiments, numerous modifications, alterations and changes to the described embodiments are possible without departing from the sphere and scope of the present invention, as defined above, and in the following claims. Accordingly, it is intended that the present invention not be limited to the described embodiments, but that it has the full scope defined by the above language, as well as equivalents thereof.

1. A vending machine, comprising:
a housing including therein
an article storage area, and
an article dispensing apparatus for moving selected articles from the storage area and dispensing them to a user of the vending machine;
an exterior portion of the vending machine housing having a clear portion so as to form a window which allows viewing into the vending machine;
a video display device positioned inside the housing and spaced behind at least a portion of the window, where a display surface of the video display device faces the window so that a substantial portion of the display surface of the video display is visible through the viewing window; and
a moving apparatus is provided for movement in the space between the window and the display surface of the video display.

2. The apparatus of claim 1, where the video display device is mounted proximate an interior wall in the housing which is substantially opposite to the window.

3. The apparatus of claim 1, further including an audio source for providing audio content that may be coordinated with image content provided by the video display.

4. The apparatus of claim 1, wherein the article storage area is positioned below the space between the window and the display surface of the video display.

5. The apparatus of claim 1, where the moving apparatus is positionable so as to move in the space between the window and the display surface of the video display, during at least some of the time before, during or after an article dispensing cycle of the article dispensing apparatus of the vending machine.

6. The apparatus of claim 1, where the moving apparatus is controlled so as to cause it to provide an entertainment effect in coordination with images and/or sounds being presented on the video display.

7. The apparatus of claim 1, where the moving apparatus is controlled so as to cause it to provide an entertainment effect as a result of sensing proximity of a potential user who is near the dispensing apparatus.

8. The apparatus of claim 1, where the moving apparatus is controlled so as to cause it to provide an entertainment effect as a result of user operation of the dispensing apparatus.

9. The apparatus of claim 1, where the moving apparatus is controlled so as to cause it to provide an entertainment effect as a result of the passage of time.

10. The apparatus of claim 6, where the entertainment effect provided by the moving apparatus includes movement of the moving apparatus while it is positioned in said space between the window and the display device.

11. The apparatus of claim 10, where the entertainment effect is provided by one or more of:
a. passive entertainment components, such as graphics, springs or reflectors, or
b. active components, such as articulated linkages or rotating mechanism, flashing lights, strobe lights, flood lights or LED'S, which components move or illuminate in coordination with actual images and/or sounds being presented on the video display.

12. The apparatus of claim 5, wherein a likeness of an article of the type which is dispensable from the vending machine is affixed to the moving apparatus.

13. (canceled)

14. The apparatus of claim 1, where at least a portion of the article dispensing apparatus of the vending machine comprises the moving apparatus.

15. The apparatus of claim 14, wherein said movement is coordinated with actions of a user of the vending machine, which actions are performed for causing a dispensing operation of the vending machine.

16. (canceled)

17. The apparatus of claim 1, further including a video camera in the housing for creating real time video for display on the video display.

18. The apparatus of claim 1, the article dispensing apparatus includes positioned thereon one or more entertainment devices, comprising one or more of:
a. passive entertainment components, such as graphics, springs or reflectors, or
b. active components, such as articulated linkages or rotating mechanism, flashing lights, strobe lights, flood lights or LED'S, which components move or illuminate in coordination with actual images and/or sounds being presented on the video display.

19. The apparatus of claim 18, where such entertainment devices move in coordination with the actual images and/or sounds being presented on and/or with images being provided by the video display device, thereby further enhancing entertainment aspects of the video display.

20. The apparatus of claim 1, wherein moving apparatus is connected to a user operated portion of the vending machine, so as to allow the user an additional way to interact or otherwise be entertained by viewing through the window.

21. The apparatus of claim 1, where the housing of the vending machine may include a window on an other wall of said housing, so as to allow an additional view into the vending machine where the video display can be observed.

22. The apparatus of claim 21, where one or more image projective devices are selectively positioned inside of the housing so as to project an image presented on the video display toward the window, so as to increase the ability of a person standing outside the machine to see images displayed on the video display from an additional viewing perspective.

23. (canceled)

24. (canceled)

25. (canceled)

26. (canceled)

27. (canceled)

28. (canceled)

29. A vending machine, comprising:
a housing including therein
an article storage area, and
an article dispensing apparatus for moving selected articles from the storage area and dispensing them to a user of the vending machine;
an exterior portion of the vending machine housing having a clear portion so as to form a window which allows viewing into the vending machine; and
a video display device coupled to an inside wall of the housing which is substantially opposed to the position of said window so as to form a space between the window and a display surface of the video display, where a display surface of the video display device faces the window so that a substantial portion of the display surface of the video display is visible through the viewing window. wherein
the article storage area is positioned below the space between the window and the display surface of the video display

30. The apparatus of claim 29, wherein a moving apparatus is provided for movement in the space between the window and the display surface of the video display.

31. The apparatus of claim 30, where the moving apparatus is positionable so as to move in the space between the window and the display surface of the video display, during at least some of the time before, during or after an article dispensing cycle of the article dispensing apparatus of the vending machine.

32. The apparatus of claim 230, where the moving apparatus is controlled so as to cause it to provide an entertainment effect in coordination with images and/or sounds being presented on the video display.

33. (canceled)

34. (canceled)

35. (canceled)

36. (canceled)

37. (canceled)

38. (canceled)

39. (canceled)

40. (canceled)
